(19) United States
(12) Patent Application Publication
(10) Pub. No.: US 2021/0360001 A1
(43) Pub. Date: Nov. 18, 2021

(54) CLUSTER-BASED NEAR-DUPLICATE DOCUMENT DETECTION

(71) Applicant: eBay Inc., San Jose, CA (US)

(72) Inventor: Scott Collins Proper, Bellevue, WA (US)

(21) Appl. No.: 16/875,559

(22) Filed: May 15, 2020

(51) Int. Cl. H04L 29/06; G06N 20/00; H04L 12/58; G06K 9/00; G06K 9/62

(52) U.S. Cl. CPC H04L 63/12; G06N 20/00; H04L 51/12; H04L 51/18; G06Q 30/0643; H04L 51/22; H04L 63/1483; H04L 63/1433; G06K 9/6267; G06K 9/00087

(57) ABSTRACT

Technologies are shown for near-duplicate detection where a message is received and a fingerprint generated for some or all of its content. A distance metric is determined between the received message fingerprint and fingerprints for a cluster of other messages. If the message fingerprint matches a fingerprint in a cluster, then the received message is added to the matching cluster. A risk value associated with the matching cluster can be determined. If the risk value is greater than a risk threshold, the received message fingerprint can be added to a risk list or an alert, notification or block indication can be generated. A fingerprint can be determined for an inquiry message and, if the inquiry message fingerprint matches a fingerprint in the risk list, then an alert can be generated. The distance metric between fingerprints correlates to a similarity between the message content corresponding to the fingerprints.

### BACKGROUND

In many applications, it can be useful to recognize similar documents. For example, detecting near-duplicates can improve the quality of a web crawler of documents if the web crawler can determine that a newly crawled web page is a near-duplicate of a previously crawled web page or not, e.g. the pages differ from one another in a small portion, such as displayed advertisements. (See “Detecting near-duplicates for web crawling.” Gurmeet Singh Manku, Arvind Jain, and Anish Das Sarma, IW3C2, May 2007.)

Near-duplicate document detection can also be useful for recognizing malicious or obnoxious documents or messages, such as emails or texts, because scammers or spammer often utilize essentially the same message content with certain differences, such as different recipients, accounts, telephone numbers, addresses or subject lines. (See “Fingerprint-Based Near-Duplicate Document Detection with Applications to SNS Spam Detection.” Ho, P.-T., & Kim, S.-R, International Journal of Distributed Sensor Networks, 2014.)

It is with respect to these and other considerations that the disclosure made herein is presented.

### SUMMARY

In certain simplified examples of the disclosed technologies, methods, systems, or computer readable media for near-duplicate detection involve receiving a message having message content, determining a message fingerprint based on at least part of the message content, determining whether the message is a near duplicate of another message by matching the message fingerprint to at least one fingerprint in a cluster of other messages, and if the message fingerprint matches at least one message in the cluster of other messages, adding an identifier for the message and the message fingerprint to the cluster of other messages.

Certain examples also involve determining a risk level for the cluster of other messages and, if the risk level for the cluster is greater than a risk threshold, adding the fingerprints of the cluster of other messages to a risk list.

Particular examples involve receiving an inquiry message with inquiry message content, determining an inquiry message fingerprint based on at least part of the inquiry message content, searching the risk list for a fingerprint matching the inquiry message fingerprint, and, if the fingerprint matching the inquiry message is found on the risk list, generating at least one of an alert, a notification, and a blocking message.

Other specific examples involve receiving an inquiry message with inquiry message content, determining an inquiry message fingerprint based on at least part of the inquiry message content, and searching one or more clusters of other messages for a fingerprint matching the inquiry message fingerprint. If the fingerprint matching the inquiry message fingerprint is found on a matching cluster of other messages, then determining a risk level for the matching cluster. If the risk level for the matching cluster is greater than a risk threshold, these examples involve generating at least one of an alert, a notification, and a blocking message if the message is a near-duplicate of any fingerprint on the risk list.

Other examples can involve training a risk detection model using machine learning applied to data for one or more clusters of other messages and one or more attributes to determine a risk level and the step of determining a risk level for the matching cluster involves predicting a risk level associated with the matching cluster of other messages using the risk detection model.

In some examples, the one or more attributes includes one or more of a sender identifier, a number of messages sent by the sender, a number of accounts associated with the sender, or a description, price, or age of an item listing.

In yet other examples, the operation of determining a message fingerprint based on at least part of the message content involves mathematically generating a fingerprint corresponding to the part of the message content using a fingerprinting algorithm and the step of determining whether the message is near duplicate of another message by matching the message fingerprint to at least one fingerprint in a cluster of other messages involves determining whether the message fingerprint is within a predetermined code distance of at least one fingerprint in a cluster of other messages.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items.

FIG. 1 is an architectural diagram showing an illustrative example of an architecture suitable for application of the disclosed technology for near-duplicate detection;

FIG. 2A is a logical architecture diagram showing an illustrative example of logical components of an application of the disclosed technology for near-duplicate detection;

FIG. 2B is a logical architecture diagram showing an illustrative example of logical components of an application of the disclosed technology for near-duplicate detection involving determining a risk level based on matching cluster data;

FIG. 2C is a logical architecture diagram showing an illustrative example of logical components of an application of the disclosed technology for near-duplicate detection involving identifying a risky message utilizing a risk list;

FIG. 2D is a logical architecture diagram showing an illustrative example of logical components for merging clusters of messages in accordance with certain aspects of the disclosed technology;

FIG. 2E is a logical architecture diagram showing an illustrative example of additional logical components for merging clusters of messages in accordance with certain aspects of the disclosed technology;

FIG. 3A is a message flow diagram showing a simplified example of an exchange of messages in an application of the disclosed technology for populating a cluster data structure;

FIG. 3B is a message flow diagram showing a simplified example of an exchange of messages in an application of the disclosed technology for near-duplicate detection involving determining a risk level based on matching cluster data;

FIG. 3C is a message flow diagram showing a simplified example of an exchange of messages in an application of the disclosed technology for near-duplicate detection involving identifying a risky message utilizing a risk list;

FIG. 4A is a control flow diagram showing an illustrative example of a process for populating a cluster data structure for near-duplicate detection in accordance with the disclosed technology;

FIG. 4B is a control flow diagram showing an illustrative example of a process for generating a risk list in accordance with the disclosed technology;

FIG. 4C is a control flow diagram showing an illustrative example of a process for detecting that an inquiry message has a high risk level involving determining a risk level based on a matching cluster of messages in accordance with the disclosed technology that can execute in a detection server or service;

FIG. 4D is a control flow diagram showing an illustrative example of a process for detecting that an inquiry message has a high risk level involving use of a risk list in accordance with the disclosed technology that can execute in a detection server or service;

FIG. 4E is a control flow diagram showing an illustrative example of a process for training a risk prediction model using machine learning in accordance with the disclosed technology;

FIG. 5 is a computer architecture diagram illustrating an illustrative computer hardware and software architecture for a computing system capable of implementing aspects of the techniques and technologies presented herein;

FIG. 6 is a diagram illustrating a distributed computing environment capable of implementing aspects of the techniques and technologies presented herein; and

FIG. 7 is a computer architecture diagram illustrating a computing device architecture for a computing device capable of implementing aspects of the techniques and technologies presented herein.

### DETAILED DESCRIPTION

The following Detailed Description describes technologies for detecting near-duplicate documents. In general terms, the disclosed technology relates to detection of near-duplicate messages (e.g. malicious messages and spam communications), documents (e.g. web pages), or data objects (e.g. binaries or image files). The disclosed technology generates a fingerprint value using a fingerprinting algorithm, e.g. SimHash, applied to some or all of the content of each of a set of messages, documents or data objects to obtain mathematical fingerprint values for the messages, documents or data objects. A characteristic of a fingerprint algorithm suitable for use in the disclosed technology is that a distance metric, e.g. a Hamming code distance, between fingerprint values corresponds to a level of difference between the documents corresponding to the fingerprints.

Technical advantages of the technology described herein include, among other fields, increased security and improved detection of similar documents for classification or other purposes. The embodiments described herein provide a scalable and performant way to detect near duplicate content, and so they allow computers to process more information while using less computational resources such as memory, storage, etc.

In addition, the disclosed technology can generate accurate results as compared with other methods, leading to better data accuracy. Computer system security is improved because duplicate messages may be a sign of fraudulent or automated message generation activity. Document similarity is an important branch of classification systems—for example, documents with close similarity may be classified into the same category. Being able to provide scalable, performant, and accurate classification across millions of documents is an important computational problem.

The fingerprints generated from multiple messages, documents or data objects can be organized and clustered based on a mathematical distance between fingerprints of the multiple messages, documents or data objects. A new message, document or object file with a fingerprint within a threshold similarity distance of a fingerprint already existing in a cluster can be added to the cluster.

For example, the cluster structure can be populated with the fingerprints for messages, documents or data objects. When a fingerprint value for a message, document or data object is found to match, e.g. is a near-duplicate of, at least one fingerprint in a cluster, then the fingerprint value and identifier for the message, document or data object is added to the matching cluster. When multiple clusters have fingerprints that match the fingerprint value for the message, document or data object, then the multiple clusters can be merged into a single larger cluster.

A risk prediction model can be utilized to determine a risk value for a cluster. The risk prediction model can be a machine learning model trained using the cluster data and one or more attributes, such as sender identity, number of sender messages, number of sender accounts, description, age, or price.

For example, a risk level can be determined for an inquiry message based on the cluster structure. An inquiry message fingerprint can be generated from some or all of the content of the inquiry message. The cluster structure can be searched for a cluster having at least one fingerprint that matches the inquiry message fingerprint. If a matching cluster is found, then data for the messages, documents or data objects in the cluster can be input to a risk detection model to determine a risk level. If the risk level exceeds a risk threshold, then an alert or notification can be generated regarding the inquiry message or the inquiry message can be blocked.

Alternatively, the cluster data can be input to the risk detection model to determine a risk level for a cluster and, if the risk level exceeds the risk threshold, then the fingerprints for the cluster can be added to a risk list. If the inquiry message fingerprint matches a fingerprint in the risk list, then an alert or notification can be generated regarding the inquiry message or the inquiry message can be blocked.

To improve the quality of fingerprints generated by SimHash, messages or documents can be pre-processed for terms or phrases with a use rate in the overall corpus of messages either greater or less than a predetermined limit (e.g. frequently used phrases, or phrases that are less important for determining similarity) and those terms or phrases stripped from the message or document before a fingerprint is determined. For example, high term frequency terms, such as “a,” “it,” “that,” “of” and “or,” can be filtered out of a document before a fingerprint is generated for the document. Similarly, low term frequency words can also be removed. In particular examples, certain terms or phrases, e.g. terms or phrases that are important for determining similarity, can be assigned weights before the fingerprint is determined. The SimHash algorithm can then use these weights to determine the relative importance of a given term or phrase.

As will be described in more detail herein, it can be appreciated that implementations of the techniques and technologies described herein may include the use of solid state circuits, digital logic circuits, computer components, and/or software executing on one or more input devices. Signals described herein may include analog and/or digital signals for communicating a changed state of the data file or other information pertaining to the data file.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including multiprocessor systems, mainframe computers, microprocessor-based or programmable consumer electronics, minicomputers, hand-held devices, and the like.

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for detecting near-duplicate documents using fingerprint-based clustering will be described. As will be described in more detail below with respect to the figures, there are a number of applications and services that may embody the functionality and techniques described herein.

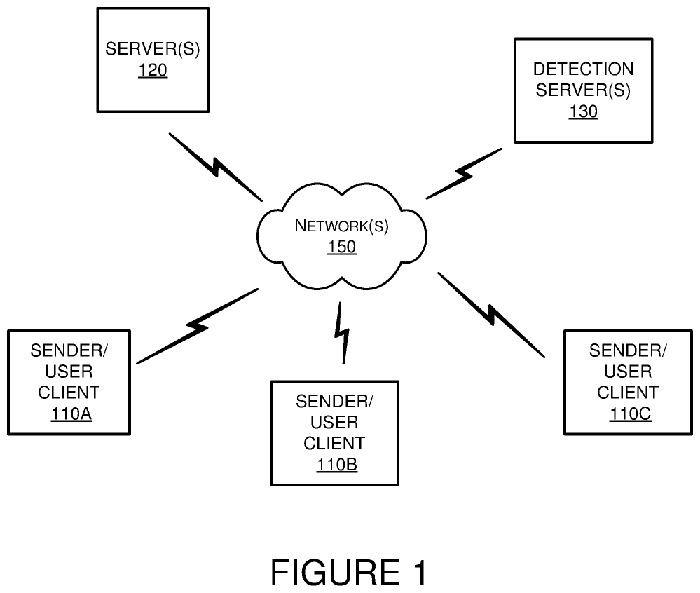

FIG. 1 is an architectural diagram showing an illustrative example of an architecture 100 suitable for application of the disclosed technology for cluster-based near-duplicate document detection. Note that the term documents is used throughout this description to refer to messages (e.g. emails, texts or other communications), documents (e.g. text documents or web pages), object files (e.g. image files, video files, executables or binaries), or data files for which near-duplicate detection may be desired.

In the example of FIG. 1, clients 110A-C, such as a user's mobile client device, personal computer, or server or client based application, is a device with an application that can communicate with one or more servers or service 120 and detection server 130 through network 150. For example, clients 110A-C can be used to send messages through network 150 to server 120, which can be an email server, document repository, eCommerce platform, web server, web-crawler or search engine, or other server or service.

Server 120 can communicate with detection server 130 through network 150 to obtain, for example, a prediction from detection server 130 that a document or object file is a near-duplicate or is associated with a particular level of risk. Detection server 130 is a platform for collecting, organizing and managing document content and associated fingerprints in a cluster data structure that facilitates near-duplicate detection. Detection server 130 can also include a risk detection model to provide a prediction of a particular risk level associated with a document, such as the risk that the document is a spam message, a scam or phishing message or the sending user may be a malicious actor.

For example, communications between clients 110A-C and server 120 can be provided to detection server through an API supported by detection server 130. Similarly, detection server can provide an API through which server 120 can submit an inquiry regarding a risk level associated with a particular message.

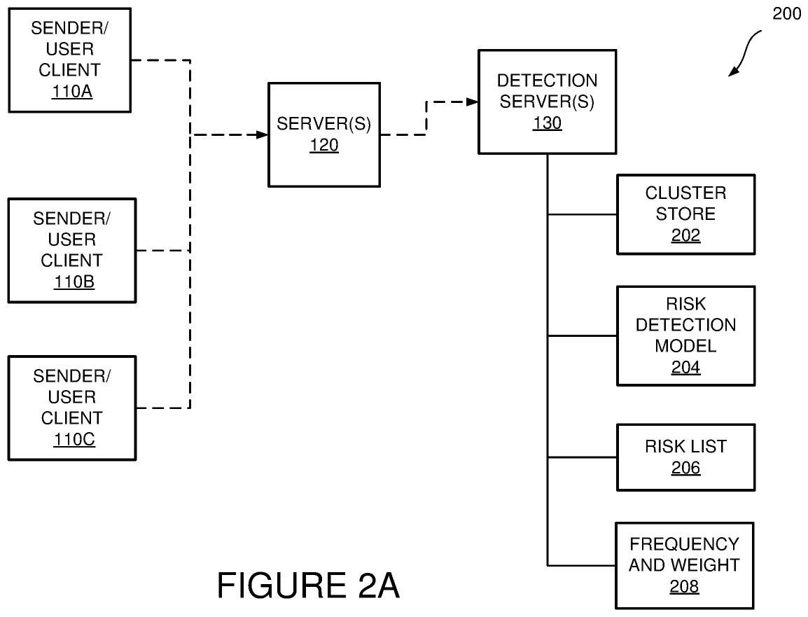

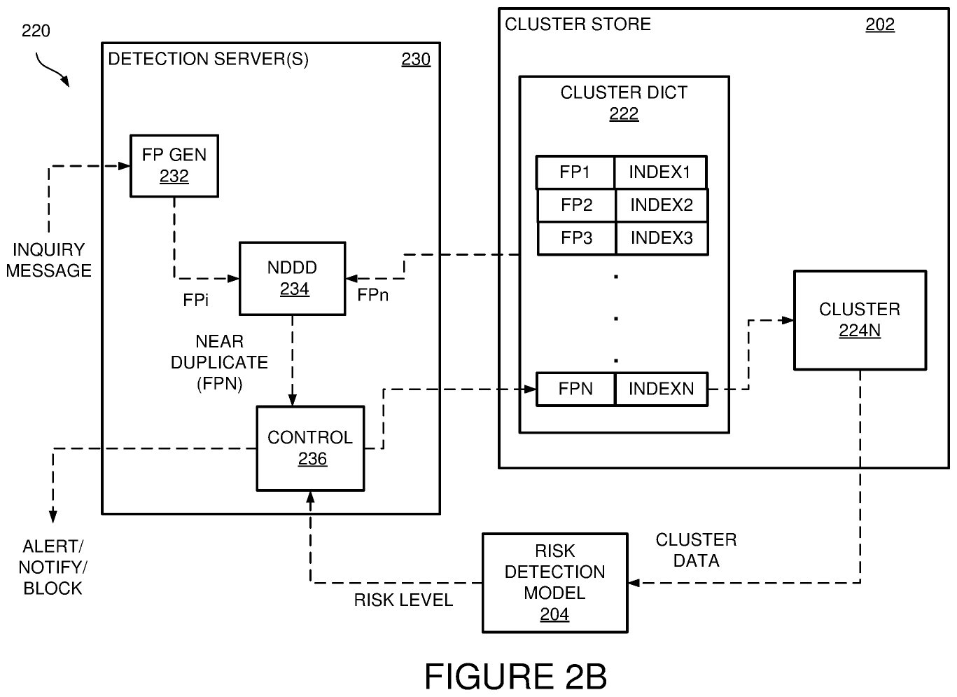

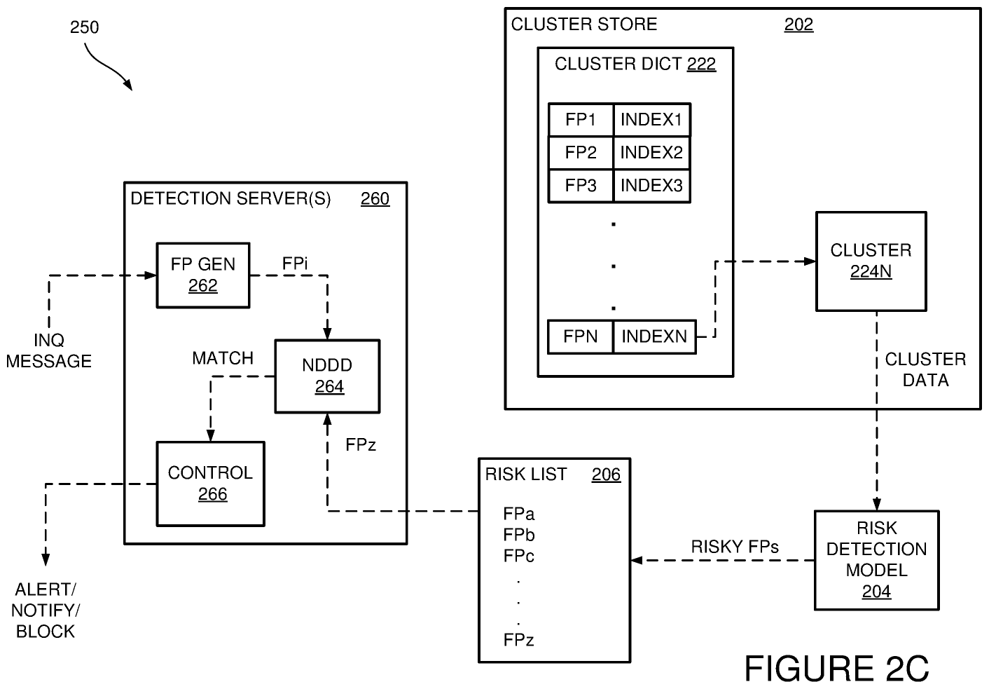

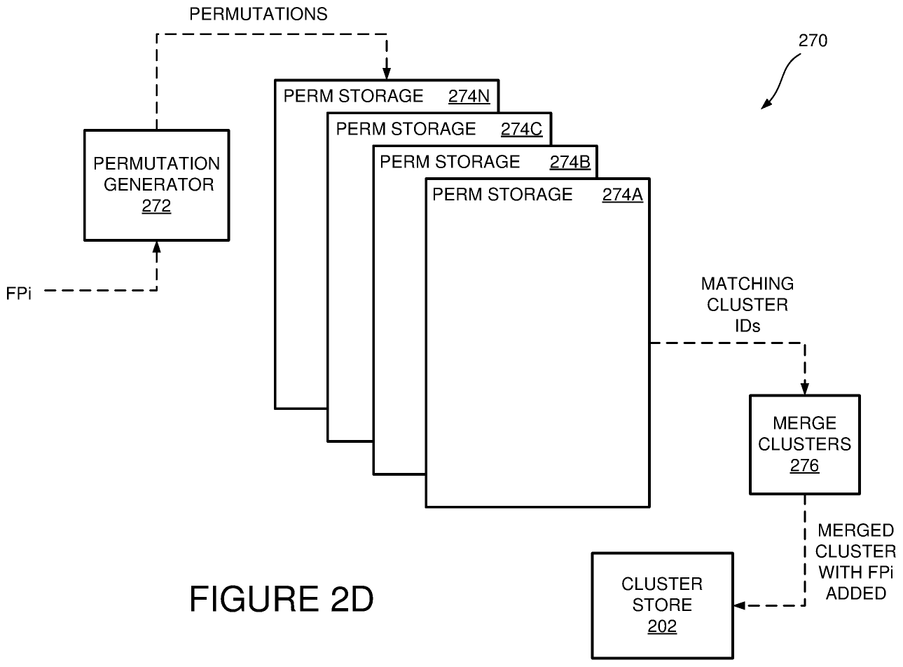

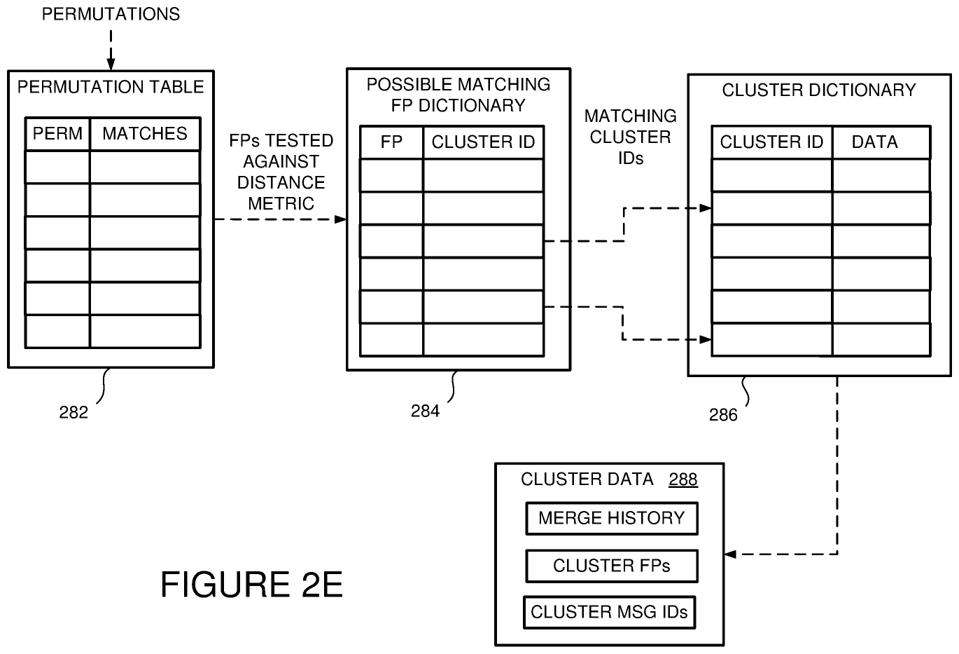

FIG. 2A is a logical diagram showing an illustrative example of logical architecture 200 of an application of the disclosed technology for near-duplicate detection. In this example, communications from clients 110A-C with server 120 are provided to detection server 130 for processing, analysis and storage in cluster store 202 that stores document content and fingerprints in a cluster structure that organizes documents into clusters of similar documents.

Detection server 130 can also include risk detection model 204, which can utilize a variety of heuristics to predict a level of risk associated with one or more documents. In some examples, fingerprints corresponding to documents with a risk level exceeding a threshold can be stored in risk list 206.

Detection server 130 can also include frequency and weight store 208. Terms or phrases with a high use-rate can be identified in store 208 and stripped from document content to remove content that may be less important to detecting near-duplicate documents. Similarly, store 208 can also identify terms or phrases with that are more highly important to detecting near-duplicate documents and those terms or phrases can be assigned higher weights for purposes of near-duplication detection.

FIG. 2B is a logical diagram showing an illustrative example of a logical architecture 220 of an application of the disclosed technology for near-duplicate detection involving determining a risk level based on matching cluster data. In this example, detection server 230 includes a fingerprint generator module 232 that receives an inquiry message, e.g. a message for which risk detection is desired, and generates a message fingerprint FPi using a fingerprinting algorithm.

Note that, in this example, a message can be a data object primarily composed of text information (i.e. “message content”), but may also include information such as a unique message identifier or an identifier for the message sender or recipient as well as other headers.

Also note that a fingerprinting algorithm, as described herein, can generally mean an algorithm that reduces the dimensionality of a data object, such as a message, document (e.g. web page), binary file, or image file to a shorter sequence of bits or characters (i.e. fingerprint) such that, in general terms, small changes in the data object result in small changes in the resulting fingerprint value. The SimHash algorithm is one example of a suitable fingerprinting algorithm that calculates a fingerprint value for at least part of the message content to obtain a mathematical fingerprint value for the message. A characteristic of a fingerprinting algorithm suitable for use herein is that a distance metric, e.g. a Hamming code distance, between fingerprint values corresponds to a level of difference between the content of the messages corresponding to the fingerprint values.

The papers “Detecting near-duplicates for web crawling” and “Fingerprint-Based Near-Duplicate Document Detection with Applications to SNS Spam Detection” noted above describe examples of fingerprinting algorithms suitable for use in certain examples of the disclosed technology.

A distance metric, in the context of comparing two fingerprint values in accordance with the disclosed technology, can generally refer to a metric that compares the fingerprint values resulting in a single real- or integer-valued result. A Hamming code distance is one example of a distance metric that can be utilized in certain examples of the disclosed technology. Generally, if a distance metric between two fingerprint values is less than a given threshold, then the two fingerprints (and their corresponding documents) can be said to be near-duplicates of each other.

Returning to FIG. 2B, the message fingerprint FPi is input to near-duplicate document detection (NDDD) module 234 along with fingerprint values FPn from clusters of messages in cluster store 202. In this example, a cluster dictionary contains fingerprint values, e.g. FP1, FP2, FP3, . . . FPN, for messages in the clusters along with corresponding indexes, e.g. INDEX1, INDEX2, INDEX3, . . . INDEXN, pointing to a cluster 224 containing the message and having fingerprints, message identifiers, and data for messages in the cluster of messages.

Further, in this example, when NDDD 234 detects a fingerprint value FPn from the cluster dictionary that is a near-duplicate of the message fingerprint FPi, e.g. the values of FPi and FPn are within a distance metric of one another, then NDDD 234 outputs the near-duplicate fingerprint, which is FPN in this example, to control module 236.

Near-duplicate document detection involves identifying two documents that are not duplicates, but have a level of similarity that meets a given threshold. In the example described above, if the mathematical fingerprints generated for two messages are within a distance metric, e.g. a code distance, then the documents are considered to be near-duplicates, i.e. matching.

There are many existing approaches to near-duplicate document detection that may be adapted for use in accordance with examples of the disclosed technology. The papers “Detecting near-duplicates for web crawling” and “Fingerprint-Based Near-Duplicate Document Detection with Applications to SNS Spam Detection” noted above describe examples of near-duplicate document detection suitable for use in particular examples of the disclosed technology. Additional examples of near-duplicate document detection algorithms are described in “Near Duplicate Document Detection,” Bassma S. Alsulami, et al., International Journal of Computer Science & Communication Networks, Vol. 2(2), 147-151.

Control module 236 uses the near-duplicate fingerprint FPN to index a cluster 224N corresponding to fingerprint FPN to obtain cluster data for the cluster. The cluster data is input to risk detection model 204 to determine a risk level value based on the cluster data for cluster 224N. Control module 236 receives the risk level value and compares the risk level value to a risk threshold. If the risk level meets the risk threshold, then control module 236 can generate an alert or a notification that the inquiry message has a high risk level as well as block the inquiry message from further processing. Control module 236 can, in some examples, generate an indication that the inquiry message is acceptable for further processing.

As one of ordinary skill in the art will appreciate, a number of variations on the process for near-duplicate document detection described with respect to architecture 220 are possible in accordance with the disclosed technology. For example, cluster store 202 can be implemented with different approaches to accessing cluster data 224 that do not utilize a cluster dictionary. Further, NDDD 234 and control 236 can be implemented in various ways within the scope of the disclosed technology.

FIG. 2C is a logical diagram showing an illustrative example of logical architecture 250 for an application of the disclosed technology for near-duplicate detection involving identifying a risky message utilizing a risk list. In this example, detection server 260 includes a fingerprint generator module 262 that receives an inquiry message, e.g. a message for which risk detection is desired, and generates message fingerprint FPi using a fingerprinting algorithm.

In this example, risk list 206 can be populated with fingerprint values, e.g. FPa, FPb, FPc, . . . FPz, that correspond to messages from cluster store 202 that are determined to be risky by risk detection model 204. For example, the cluster data for each cluster 224 in cluster store 202 is output to risk detection model 204 and, if the risk level for the cluster meets a risk threshold, the fingerprint values for the cluster are added to risk list 206.

NDDD 264 receives message fingerprint FPi and determines whether risk list 206 has a near-duplicate or matching fingerprint. In this example, fingerprint FPz from risk list 206 is a near-duplicate of message fingerprint FPi, e.g. the difference between FPi and FPz is less than a difference metric, such as a Hamming code distance. NDDD 264 outputs a MATCH indicator to control module 266, which can generate an alert or a notification that the inquiry message is determined to be risky as well as block the inquiry message from further processing. Control module 266 can, in some examples, generate an indication that the inquiry message is acceptable for further processing, e.g. routing the inquiry message to a designated recipient.

The cluster structure for clusters of near-duplicate messages in cluster store 202 can facilitate fast and efficient identification of clusters of messages that match an inquiry fingerprint. In general terms, a cluster is a group of documents, e.g. messages that are near-duplicates of one another and can include relevant information such as message identifiers, fingerprints, or a history of past merges with other clusters. In the context of near-duplicate document detection, these clusters are generally constructed on the basis of the transitive property, such that all messages in a cluster are directly or indirectly near-duplicates of each other.

The transitive property, in the context of near-duplicate document detection, provides that, for three documents A, B, and C; and A and B are near duplicates of each other, and likewise B and C are near-duplicates, then A and C may also be said to be near-duplicates.

The transitive property allows for the merging of multiple clusters when the multiple clusters are found to each be near-duplicates of a message fingerprint. Merging, in this context, refers to the process of combining two or more clusters. Generally, this will occur when a new message fingerprint is observed that is a near-duplicate of fingerprints that exist in two or more clusters. The transitive property then suggests that these clusters should be merged into a single cluster.

In one example, as messages are processed to populate the cluster structure in cluster store 202, multiple clusters can be found having fingerprints that match a fingerprint being added to the cluster structure. Due to the transitive character of near-duplicate documents, these matching clusters can be merged when they are found to have fingerprints that match an inquiry fingerprint. Merging clusters can contribute to speed and efficiency in detecting near-duplicate documents using the cluster structure.

FIGS. 2D and 2E are logical architecture diagrams showing an illustrative example of logical components in a data architecture for merging clusters of messages in accordance with certain aspects of the disclosed technology. In the example of FIG. 2D, a fingerprint value FPi for a message is processed by permutation generator 272 to obtain one or more permutations of the fingerprint FPi. Each of the permutations generated by permutation generator 272 is used to index into a corresponding permutation table, of which there are four illustrated in this example 274A, 274B, 274C or 274N. Note that, while four permutation tables are used in this example, other implementations can have more or fewer permutation tables.

The data in permutation tables 274A, 274B, 274C and 274N are analyzed to identify clusters having at least one fingerprint value that matches, e.g. is a near-duplicate, of message fingerprint FPi. As noted herein, multiple clusters can have fingerprints that match FPi. The identifiers for the matching clusters are output to merge clusters module 276 to merge each of the matching clusters into a larger merged cluster and add the message fingerprint. The resulting merged cluster can then be stored in cluster store 202.

In the example of FIG. 2E, a single permutation is shown indexed into its corresponding permutation table 282 and the fingerprints matching that permutation are tested against a distance metric to identify fingerprints that are a near-duplicate to the message fingerprint FPi. Possible matching fingerprint dictionary 284 provides a mapping from the possible matching fingerprints to cluster identifiers.

Cluster dictionary 286 is then used to match the identifiers for the matching clusters to cluster data for the matching clusters, e.g. an index, pointer, or link to a cluster data structure. When the cluster data from multiple matching clusters can be merged by cluster merging module 276 into a single larger merged cluster, the cluster data for each matching cluster is added to cluster data structure 288 for the larger merged cluster, which can include the message fingerprints and identifiers from each of the merged clusters along with a merge history that can identify the clusters that were merged. The merged cluster data structure can be stored in cluster store 202 for use in cluster-based near-duplicate document detection in accordance with the disclosed technology.

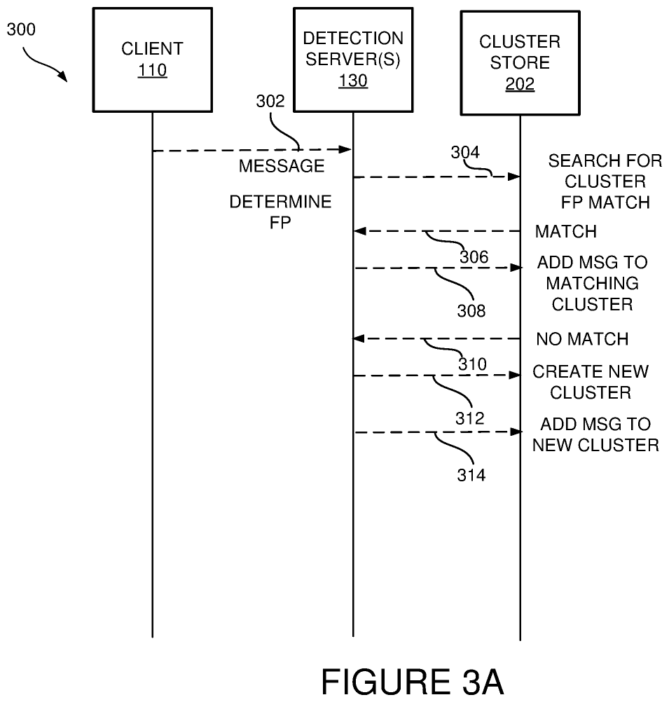

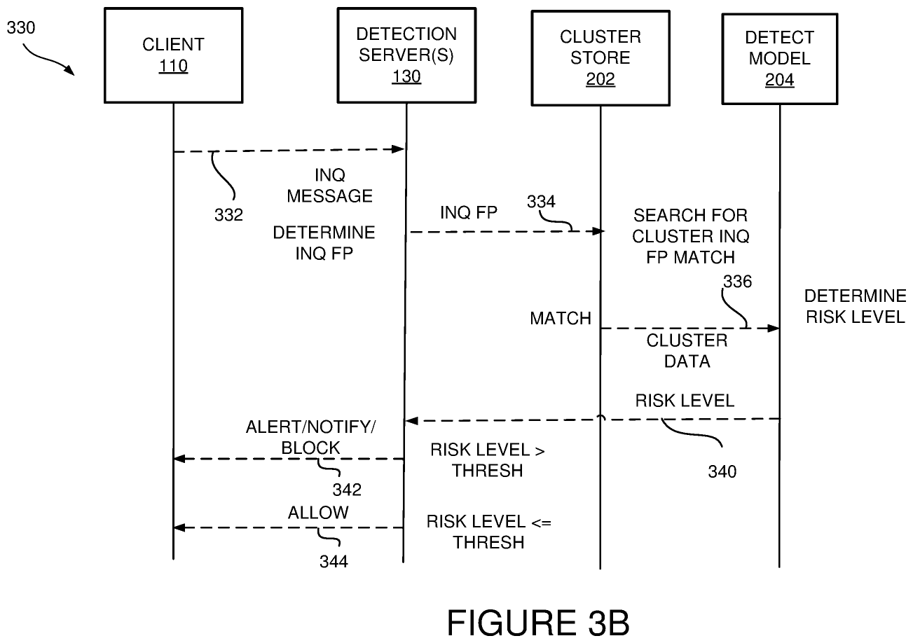

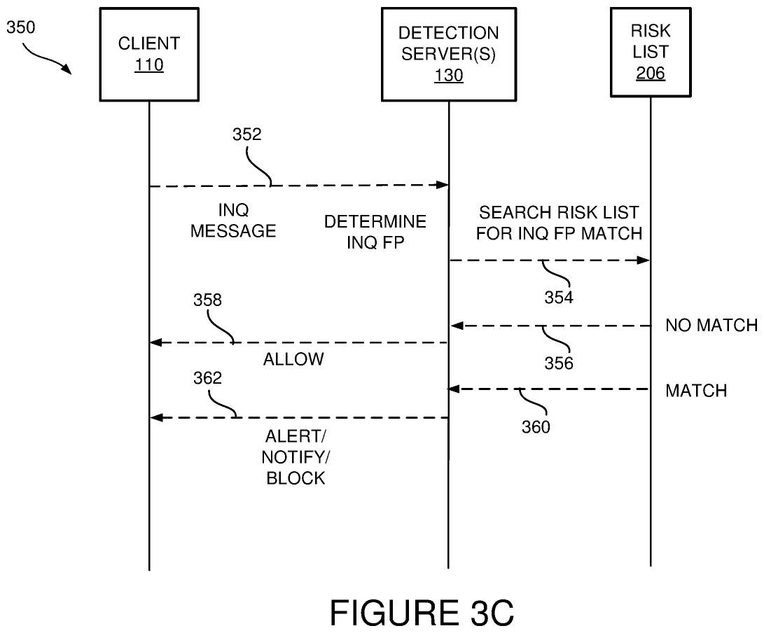

FIG. 3A is a message flow diagram showing a simplified example of an exchange of messages 300 in an application of the disclosed technology for populating cluster store 202 with clusters of messages for use as described herein.

In this example, at 302, messages can be received, e.g. directly from monitoring network 150 or indirectly from server 120 through an API, from clients, e.g. client 110, by detection server 130, which determines a message fingerprint value. At 304, cluster store 202 is searched for at least one cluster of messages having at least one fingerprint value that is a match, e.g. a near-duplicate, of the message fingerprint value from the received message.

If a matching cluster is found, at 306, then, at 308, an identifier and message fingerprint for the received message can be added to the matching cluster. If no matching cluster is found, at 310, then, at 312, a new cluster is created and, at 314, an identifier and message fingerprint for the received message can be added to the new cluster.

Note that it can be possible that more than one cluster of messages can be found to match the message fingerprint. When multiple matching clusters are found, the multiple clusters can be merged to form a single larger cluster that includes the message identifiers and message fingerprints for the messages in the multiple matching clusters. The larger cluster can also include a history of the merged clusters.

Multiple clusters can be merged because near-duplication is a transitive property: if there are three documents A, B, and C, and A and B are found to be near-duplicates, and B and C are found to be near-duplicates, then A and C may also be considered to be near-duplicates. This property naturally allows clusters to form and to be merged when a new message is found to be a near-duplicate to a fingerprint in each cluster.

FIG. 3B is a message flow diagram showing a simplified example of an exchange of messages 330 in an application of the disclosed technology for near-duplicate detection involving determining a risk level based on matching cluster data. At 332, an inquiry message is received by detection server 130, which determines a message fingerprint for the inquiry message.

The message fingerprint is used, at 334, to determine if at least one fingerprint in a cluster of messages in message store 202 is a match. If a match is found, then, at 336, cluster data from the matching cluster is input to the risk detection model 204 to determine a risk level. The risk level is returned, at 340, to detection server 130.

In this example, detection server 130 determines whether the risk level exceeds a risk threshold. If the risk level exceeds the risk threshold, then, at 342, detection server 130 generates an alert or notification and can block further processing or routing of the inquiry message. If the risk level does not exceed the risk threshold, then, at 344, the detection server 130 can generate an allow indicator that permits normal processing flow for the inquiry message to proceed.

FIG. 3C is a message flow diagram showing a simplified example of an exchange of messages 350 in an application of the disclosed technology for near-duplicate detection involving identifying a risky message utilizing a risk list. At 352, an inquiry message is received by detection server 130, which determines a message fingerprint for the inquiry message.

The message fingerprint is used, at 354, to determine if at least one fingerprint in risk list 206 is a match, e.g. near-duplicate. If no match is found, at 356, then an allow indicator is generated at 358 to allow normal processing of the message to resume. If a match in the risk list 206 is found, at 360, then, at 336, then an alert or notification or a block indication can be generated at 362.

Note that risk list 206 can be generated in a backend process that analyzes cluster data in cluster store 202 with the risk detection model 204 to identify fingerprints for risky messages, which are added to risk list 206. Risk list 206 can be distributed or shared with other detection servers or services.

Detection model 204 can be defined to detect risky messages through rules based on one or more attributes of the messages in cluster store 202. For example, message attributes can include sender identity, number of sender messages, number of sender accounts, or item description, price, and age, e.g. for an auction listing. The rules of the detection module can also be provided or combined with rules from multiple sources, e.g. rules based on wider industry or enterprise intelligence activity. It can be readily recognized that a wide variety of attributes can be utilized according to the type of message or document that is the subject of the cluster store and the detection module.

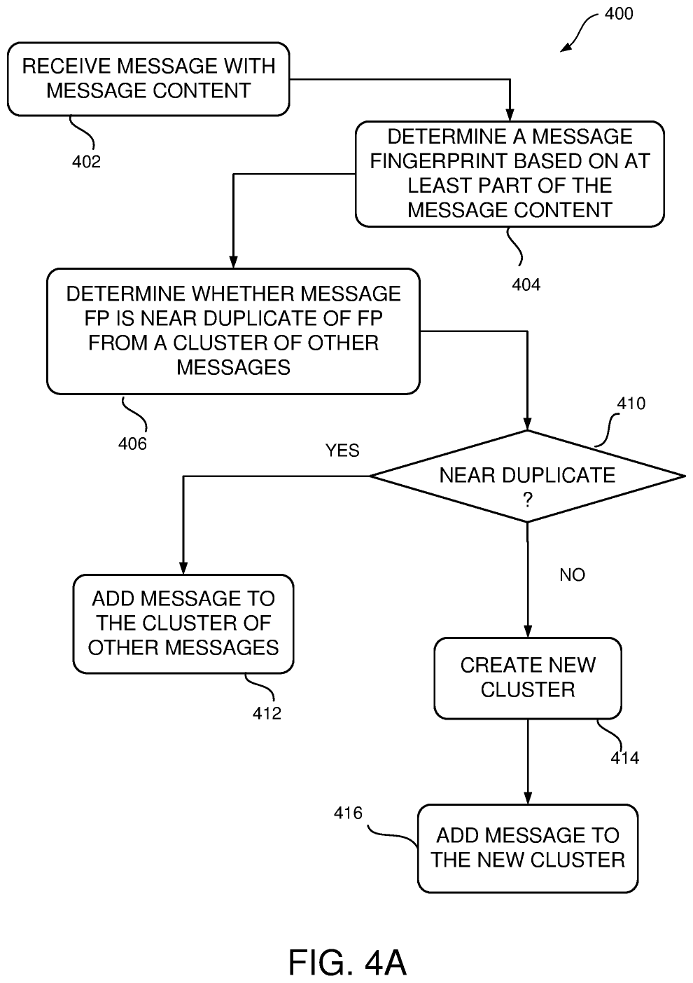

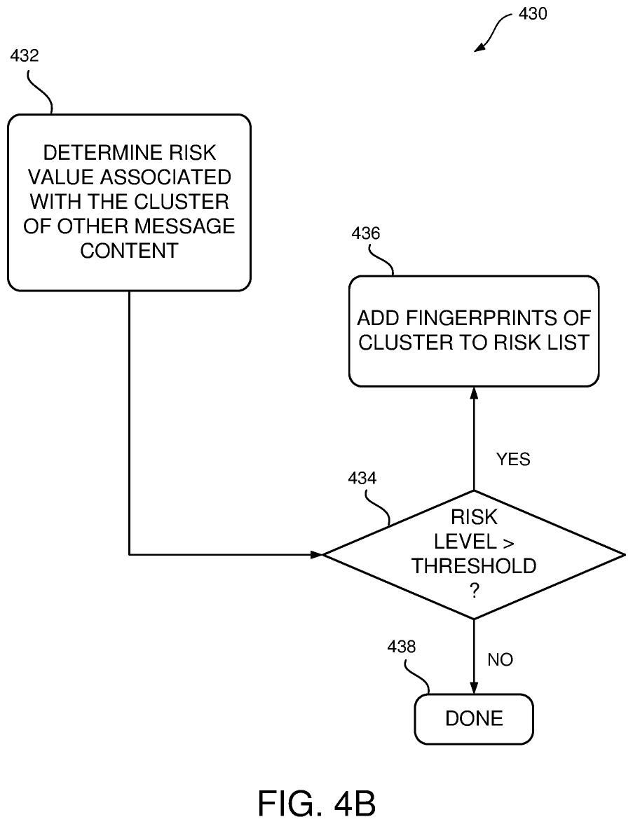

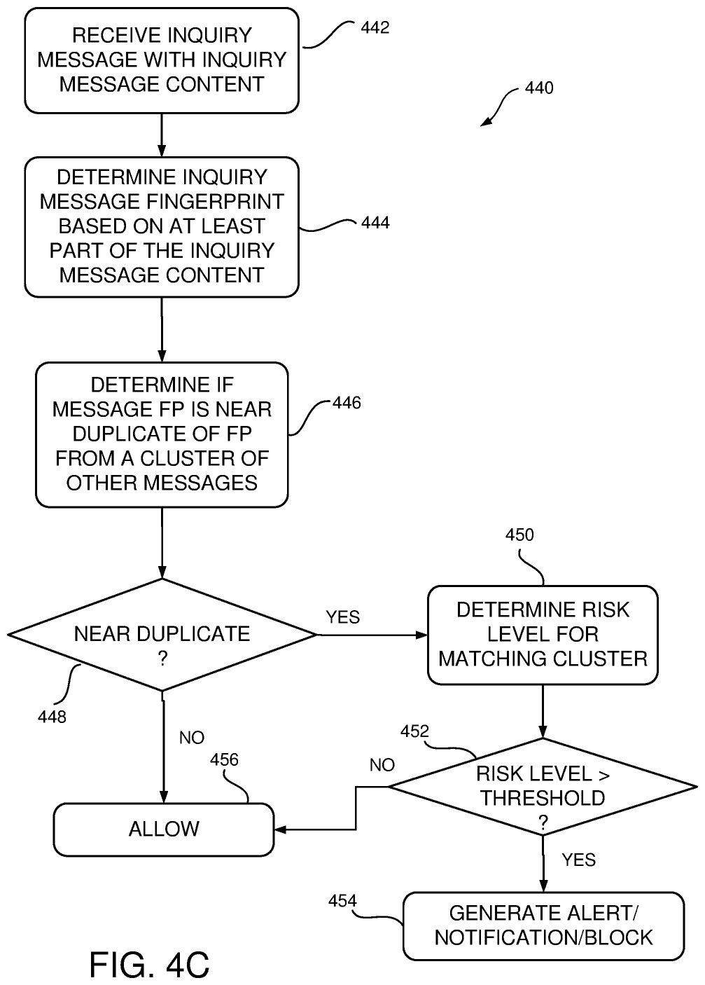

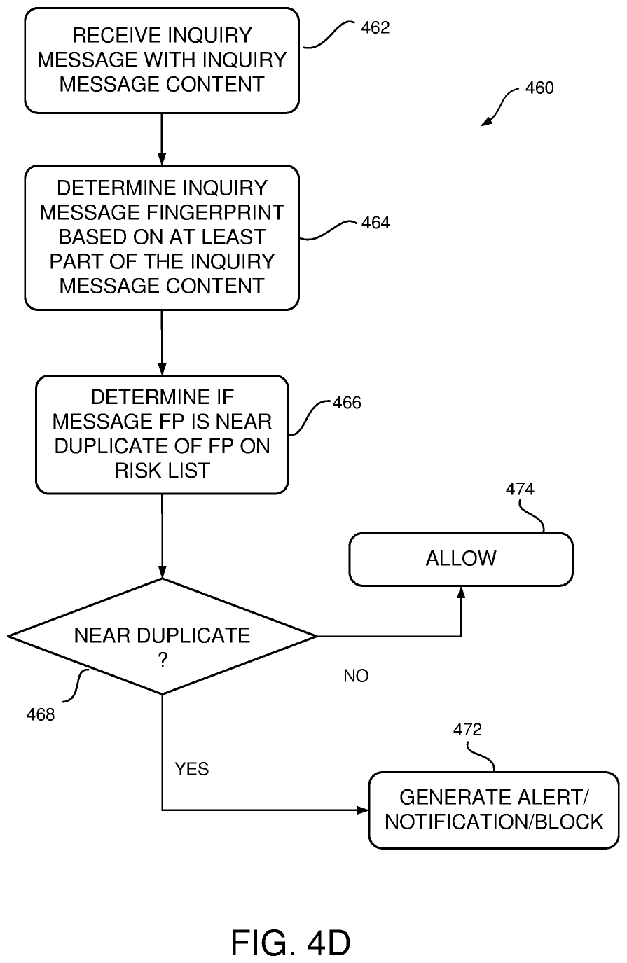

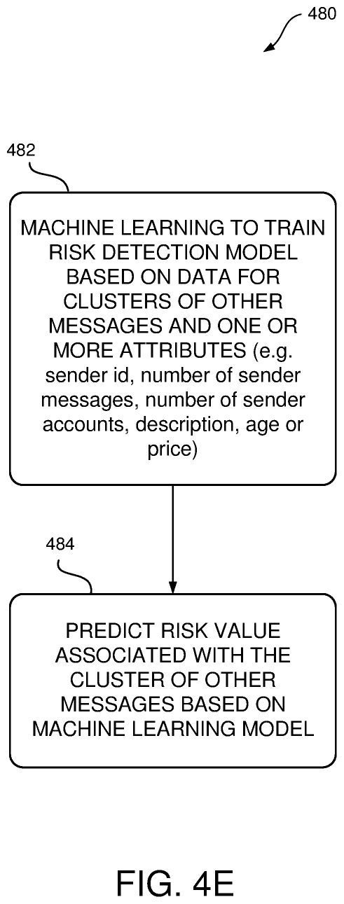

Alternatively, the detection model can be trained using machine learning based on the message content data in cluster store 202 along with one or more additional attributes. Training the detection model using machine learning is further discussed with respect to FIG. 4E below.

The example of FIGS. 3A and 3B are directed toward messages, such as emails or texts, but the disclosed technology is not limited to messages. In other applications of the disclosed technology, for example, the alert, notification or block can involve a document, object file or data file and cluster store 202 can be populated with clusters of documents object files or data files. For example, a web page submitted as a document by a web crawler can be determined to be a near-duplicate of a web page in a cluster of web pages that are already cached and, therefore, will not be cached. In another example, a binary object file can be determined to be a near-duplicate of another binary object and, therefore, flagged. The disclosed technology can be suitable for a wide variety of applications where it is useful to identify near-duplicate files or objects.

FIG. 4A is a control flow diagram showing an illustrative example of a process 400 for populating a cluster data structure, such as a cluster structure in cluster store 202, for near-duplicate detection in accordance with the disclosed technology that can execute in a server or service, such as detection server 130 in FIG. 1. In the disclosed technology, fingerprints can be generated from multiple messages, documents or data objects that can be organized and clustered based on a difference metric between fingerprint values of the multiple messages, documents or data objects. A new message, document or object file with a fingerprint within a threshold difference metric of a cluster can be added to the cluster.

In this example, at 402, a message is received along with content for the message. At 404, a fingerprint value is determined for the message content. In certain examples, the disclosed technology calculates a fingerprint value using the SimHash algorithm for at least part of the message content, e.g. a payload and a source identifier, to obtain a mathematical fingerprint value for the message content.

As noted herein, a characteristic of a fingerprint algorithm suitable for use herein is that a distance metric, e.g. a Hamming code distance, between fingerprint values corresponds to a level of difference between the message content corresponding to the fingerprint values. As noted throughout, this aspect of the disclosed technology can be applied to other content, such as documents, objects or data files.

At 406, a determination is made as to whether the message fingerprint is a near-duplicate of at least one fingerprint from a cluster of other messages. For example, a fingerprint value in a cluster of other message content is found in a cluster data structure in cluster store 202 that is within a predetermined Hamming distance of the message fingerprint value for the received message.

At 410, if a cluster with a near-duplicate fingerprint is found, then control branches to 412 to add an identifier and the fingerprint of the received message to the cluster found with a near-duplicate fingerprint. If no cluster is found, then control branches at 410 to 414 to create a new cluster in cluster store 202. At 416, the identifier and fingerprint of the received message are added to the new cluster.

In certain examples, for purposes of creating a cluster structure in cluster store 202, the fingerprints can be divided into chunks or subsets. The value of each chunk of the fingerprint can be used to index a table of dictionaries of pointers to clusters in cluster store 202 where each cluster, when populated, includes a set of fingerprints within a given mathematical distance of one another.

If the chunk or subset resolves to an entry for the chunk, then the entry will include a pointer to a cluster and the fingerprint is added to the cluster along with an identifier for the document corresponding to the fingerprint. If there is no entry in the table of dictionaries for a chunk, then the clusters are searched for a cluster having fingerprints within a predetermined mathematical distance of the fingerprint under consideration.

If a cluster is found within the predetermined mathematical distance, then an entry is added to the table of dictionaries at the chunk index that includes a pointer to the found cluster and the fingerprint is added to the found cluster along with an identifier for the document corresponding to the fingerprint.

If no cluster is found within the predetermined mathematical distance, then a new cluster can be created, an entry is added to the table of dictionaries at the chunk index with a pointer to the created cluster, and the fingerprint can be added to the created cluster along with an identifier for the document corresponding to the fingerprint.

In another example, generally speaking, fingerprints generated from content can be organized and clustered based on a mathematical distance or difference metric between fingerprints. This can be done by dividing fingerprints into chunks or subsets. The value of each chunk of the fingerprint may be referred to as a permutation, and can be used to index into a table of dictionaries of pointers to clusters where each cluster, when populated, includes a set of fingerprints within a given mathematical distance of one another.

Here is an example of dividing a 64-bit fingerprint into four chunks or subsets: 0000000000000000000000000000000000000000000000001111111111111111 0000000000000000000000000000000011111111111111110000000000000000 0000000000000000111111111111111100000000000000000000000000000000 1111111111111111000000000000000000000000000000000000000000000000

In this example, the “l's” in each row indicate the set of bits used to create a permutation, used to index into a table of dictionaries of potential near-duplicate fingerprints. Each such fingerprint points to its corresponding cluster. The “0's” indicate the information that must be stored in the permutation table and associated dictionaries. See “Detecting Near-Duplicates for Web Crawling,” Manku et al., WWW 2007 for one example of a use of the SimHash fingerprinting algorithm in concert with an algorithm for near-duplicate document detection suitable for use in certain examples of the disclosed technology.

If the chunk or subset resolves to an entry for the chunk, then the entry can include a pointer to a cluster and the fingerprint can be added to the cluster along with an identifier for the document corresponding to the fingerprint.

If there is no entry in the table of dictionaries for a chunk, then the clusters can be searched for a cluster having fingerprints within a predetermined mathematical distance of the fingerprint under consideration.

In this example, if such a cluster is found, then an entry can be added to the table of dictionaries at the chunk index that includes a pointer to the found cluster and the fingerprint is added to the found cluster along with an identifier for the document corresponding to the fingerprint. If no such cluster is found, then a new cluster can be created, an entry can be added to the table of dictionaries at the chunk index with a pointer to the created cluster and the fingerprint is added to the created cluster along with an identifier for the document corresponding to the fingerprint.

Note that it can be possible for a fingerprint to index to multiple clusters in certain examples. When this occurs, the multiple clusters can be merged to form a single larger cluster. The larger cluster can include a history of the merged clusters.

FIG. 4B is a control flow diagram showing an illustrative example of a process 430 for adding fingerprints from a cluster of messages to a risk list, such as risk list 206, for near-duplicate document detection in accordance with particular examples of the disclosed technology that can execute in a detection server or in an backend service.

At 432, a determination is made of a risk value associated with a cluster of message content to which a message was added in process 400. The determination can be made by a risk detection model. For example, a suspicion model, i.e. a model having multiple heuristics relating to known characteristics of suspicious documents, can applied to cluster data, such as the messages or documents for the clusters, to identify suspicious clusters. The fingerprints from a suspicious cluster can then added to a list of suspicious fingerprints, such as risk list 206.

At 434, if the risk level determined for a cluster exceeds a risk threshold, then control branches to 436 and the fingerprints for the cluster are added to the risk list. If the risk level is not exceeds, then control branches to 438 and the fingerprints for the cluster are not added to the risk list.

FIG. 4C is a control flow diagram showing an illustrative example of a process 440 for detecting that an inquiry message has a high risk level involving determining a risk level based on a matching cluster of messages in accordance with the disclosed technology that can execute in a detection server or service.

At 442, an inquiry message is received having inquiry message content. At 444, a message fingerprint for the inquiry message is determined by applying a fingerprinting algorithm, e.g. SimHash, to all or part of the content of the inquiry message. At 446, a near-duplicate detection algorithm is utilized to determine if the message fingerprint value is a near duplication of at least one fingerprint from a cluster of other messages, e.g. in cluster store 202.

At 448, if a near-duplicate fingerprint is not found, then control branches to 456 to generate at allow indicator, in this example. If a near-duplicate fingerprint is found, then control branches to 450 to determine a risk level for the matching cluster of other messages, e.g. by inputting cluster data from the cluster to risk detection model 204.

If the risk level exceeds a predetermined or algorithmically calculated risk threshold, then control branches to 454 to generate an alert, notification or blocking indication. If the risk level does not exceed the risk threshold, then control branches to 456 to generate the allow indicator.

FIG. 4D is a control flow diagram showing an illustrative example of a process 460 for detecting that an inquiry message has a high risk level involving use of a risk list, such as risk list 206, in accordance with the disclosed technology that can execute in a detection server or service.

At 462, an inquiry message is received for risk detection. At 464, a fingerprint of the inquiry message content is determined based on all or part of the inquiry message content. At 466, a determination is made as to whether a fingerprint in the risk list matches the message fingerprint. For example, a near-duplication document detection algorithm determines that a fingerprint from the risk list is within a difference metric, e.g. a Hamming code distance, of the fingerprint of the inquiry message.

If a near-duplicate fingerprint is not found in the risk list, then control branches at 468 to 474 to generate an allow indicator. If a near-duplicate fingerprint is found in the risk list, then control branches at 468 to 472 to generate an alert or notification or to block the inquiry message.

In general terms, in another example, an inquiry fingerprint of an inquiry document is determined using a fingerprinting algorithm. A determination is made as to whether a fingerprint on a risk list, e.g. a list of suspicious document fingerprints, is a near-duplicate of the inquiry fingerprint. If a near-duplicate fingerprint is found on the risk list, then a notification is generated for the inquiry document.

FIG. 4E is a control flow diagram showing one illustrative example of a process 480 for training risk prediction model 204 using machine learning in accordance with the disclosed technology that can be executed in a detection server or back-end service.

At 482, machine learning is applied to the clusters of message content, such as the cluster data in cluster store 202 along with one or more message attributes. Examples of message attributes that may be used in various implementations can include a sender identifier, a number of sender messages sent, a number of accounts associated with the sender, or an item description, price, and age.

At 484, the machine trained risk prediction model 204 is applied to cluster data for a cluster of message content to predict a risk level value associated with the cluster.

As noted elsewhere herein, the approach of the disclosed technology can be applied in contexts other than messages. For example, in a web crawler or caching context, the fingerprints in the risk list can relate to web pages that have already been crawled or cached. The fingerprint of a new web page can be compared to the fingerprints in the risk list to determine whether to store the web page. Similarly, a fingerprint for a new document for a document repository can be compared to a risk list with fingerprints for documents that have already been stored to avoid storing near-duplicates of the same document.

Note that pre-processing of messages or documents to weighting words and phrases from a message can be performed that can facilitate near-duplication document detection in accordance with the disclosed technology. In one example of pre-processing, terms or phrases are checked against a dictionary of terms and phrases along with weights for the terms and phrases. For example, a word or phrase with a use-rate above a user-rate limit can be assigned a lower weight in the received message for purposes of further processing to detect near duplicates. Conversely, a term or phrase that is more important can be assigned a higher weight for purposes of near-duplicate document detection.

The weight associated with a term or phrase can be utilized in certain examples of mathematical fingerprint generating algorithms. For example, the weight of each term or phrase can be utilized in a SimHash algorithm used to generate a fingerprint by substituting the weight of a term in place of “1” and “−1” in the SimHash algorithm.

It should be appreciated that a variety of different instrumentalities and methodologies can be utilized to establish wireless communication as well as collect, exchange and display sensor and message data without departing from the teachings of the disclosed technology. The disclosed technology provides a high degree of flexibility and variation in the configuration of implementations without departing from the teachings of the present disclosure.

The present techniques may involve operations occurring in one or more machines. As used herein, “machine” means physical data-storage and processing hardware programed with instructions to perform specialized computing operations. It is to be understood that two or more different machines may share hardware components. For example, the same integrated circuit may be part of two or more different machines.

One of ordinary skill in the art will recognize that a wide variety of approaches may be utilized and combined with the present approach to trust delegation. The specific examples of different aspects of trust delegation described herein are illustrative and are not intended to limit the scope of the techniques shown.

### Computer Architectures for Cluster-Based Near-Duplicate Document Detection

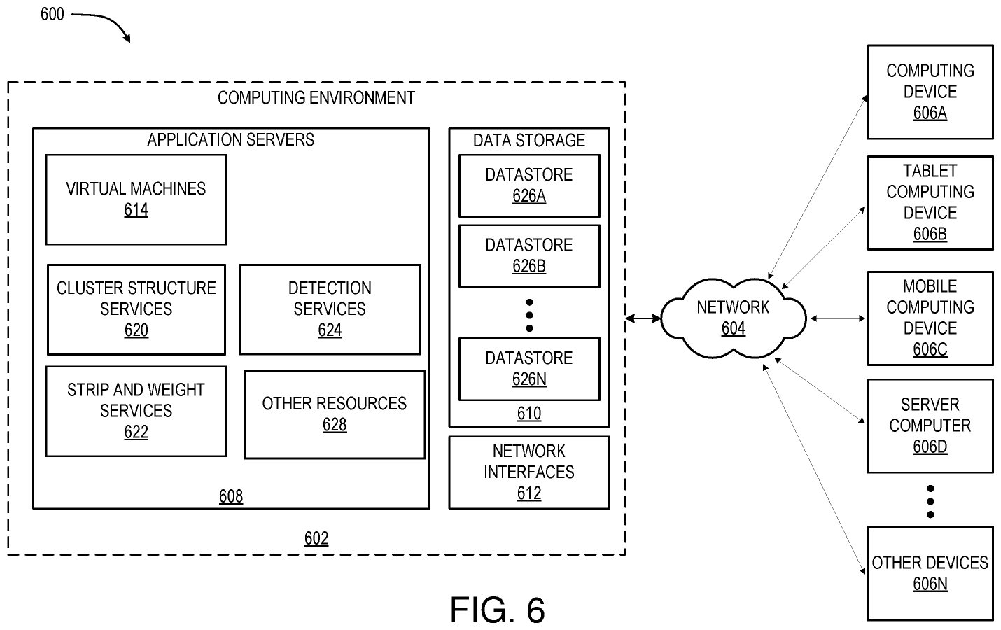

Note that at least parts of processes 400, 430, 400, 460 and 480 of FIGS. 4A-E and other processes and operations pertaining to trust delegation described herein may be implemented in one or more servers, such as computer environment 600 in FIG. 6, or the cloud, and data defining the results of user control input signals translated or interpreted as discussed herein may be communicated to a user device for display. Alternatively, the authentication service processes may be implemented in a server or in a cloud service. In still other examples, some operations may be implemented in one set of computing resources, such as servers, and other steps may be implemented in other computing resources, such as a client device.

It should be understood that the methods described herein can be ended at any time and need not be performed in their entireties. Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As described herein, in conjunction with the FIGURES described herein, the operations of the routines (e.g. processes 400, 430, 440, 460 and 480 of FIGS. 4A-E) are described herein as being implemented, at least in part, by an application, component, and/or circuit. Although the following illustration refers to the components of FIGS. 4A-E, it can be appreciated that the operations of the routines may be also implemented in many other ways. For example, the routines may be implemented, at least in part, by a computer processor or a processor or processors of another computer. In addition, one or more of the operations of the routines may alternatively or additionally be implemented, at least in part, by a computer working alone or in conjunction with other software modules.

For example, the operations of routines are described herein as being implemented, at least in part, by an application, component and/or circuit, which are generically referred to herein as modules. In some configurations, the modules can be a dynamically linked library (DLL), a statically linked library, functionality produced by an application programing interface (API), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

Although the following illustration refers to the components of the FIGURES discussed above, it can be appreciated that the operations of the routines (e.g. processes 400, 430, 440, 460 and 480 of FIGS. 4A-E) may be also implemented in many other ways. For example, the routines may be implemented, at least in part, by a processor of another remote computer or a local computer or circuit. In addition, one or more of the operations of the routines may alternatively or additionally be implemented, at least in part, by a chipset working alone or in conjunction with other software modules. Any service, circuit or application suitable for providing the techniques disclosed herein can be used in operations described herein.

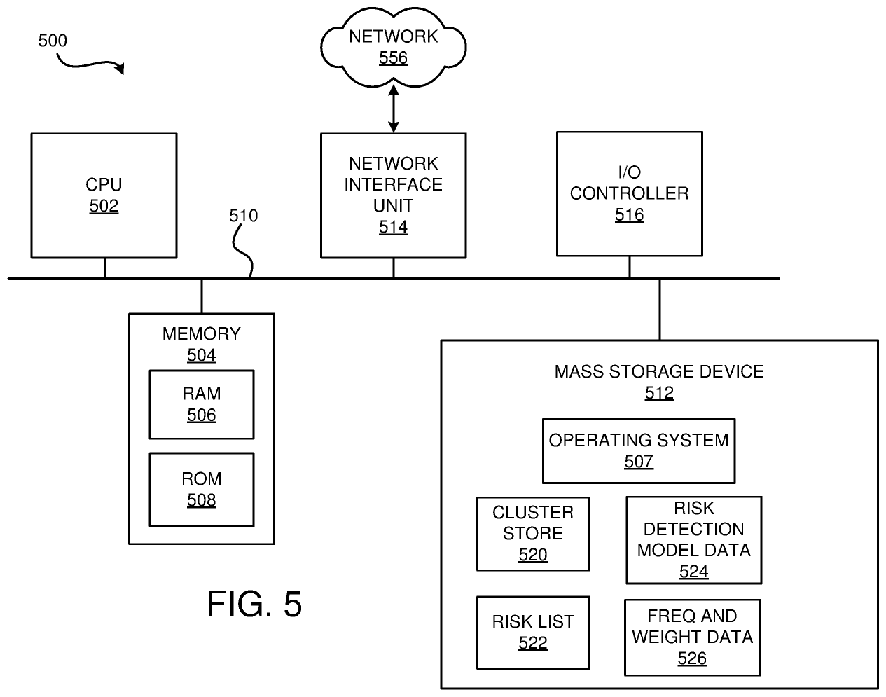

FIG. 5 shows additional details of an example computer architecture 500 for a computer, such as the devices 110A-C, 120 and 130 in FIG. 1, capable of executing the program components described herein. Thus, the computer architecture 500 illustrated in FIG. 5 illustrates an architecture for an on-board vehicle computer, a server computer, mobile phone, a PDA, a smart phone, a desktop computer, a netbook computer, a tablet computer, an on-board computer, a game console, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between sub-elements within the computer architecture 500, such as during startup, is stored in the ROM 508. The computer architecture 500 further includes a mass storage device 512 for storing an operating system 507, data (cluster store 520 where content data is stored in a cluster structure, risk list 522, risk detection model data 524 and frequency and weight data 526), and one or more application programs.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium,” “computer-readable storage medium” and variations thereof, does not include waves, signals, and/or other transitory and/or intangible communication media, per se.

According to various configurations, the computer architecture 500 may operate in a networked environment using logical connections to remote computers through the network 556 and/or another network (not shown). The computer architecture 500 may connect to the network 556 through a network interface unit 514 connected to the bus 510. It should be appreciated that the network interface unit 514 also may be utilized to connect to other types of networks and remote computer systems. The computer architecture 500 also may include an input/output controller 516 for receiving and processing input from a number of other devices, including a keyboard, mouse, game controller, television remote or electronic stylus (not shown in FIG. 5). Similarly, the input/output controller 516 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

FIG. 6 depicts an illustrative distributed computing environment 600 capable of executing the software components described herein for trust delegation. Thus, the distributed computing environment 600 illustrated in FIG. 6 can be utilized to execute many aspects of the software components presented herein. For example, the distributed computing environment 600 can be utilized to execute one or more aspects of the software components described herein.

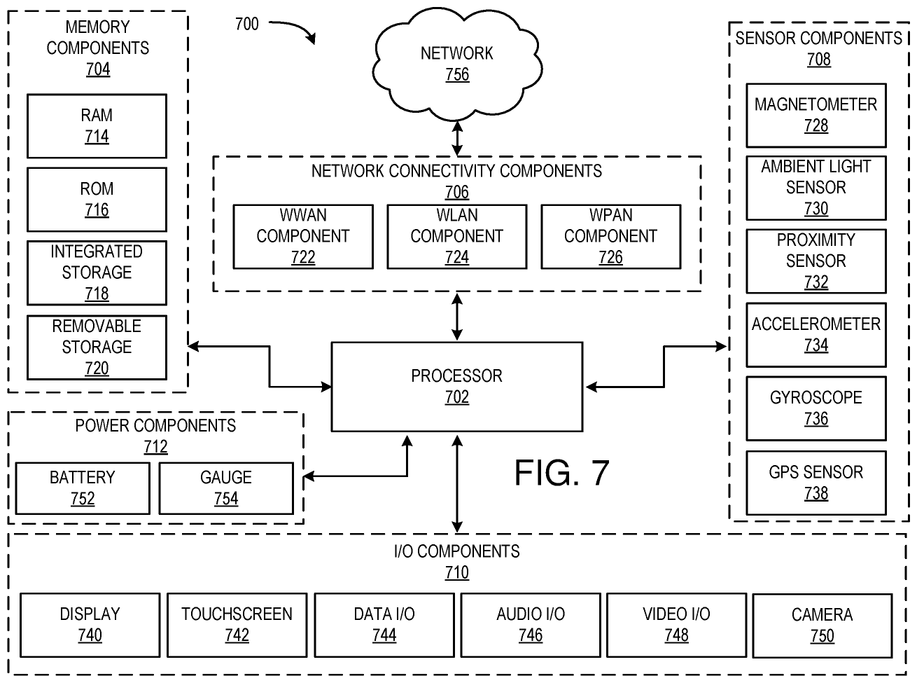

According to various implementations, the distributed computing environment 600 includes a computing environment 602 operating on, in communication with, or as part of the network 604. The network 604 may be or may include the network 556, described above. The network 604 also can include various access networks. One or more client devices 606A-806N (hereinafter referred to collectively and/or generically as “clients 606”) can communicate with the computing environment 602 via the network 604 and/or other connections (not illustrated in FIG. 6). In one illustrated configuration, the clients 606 include a computing device 606A, such as a laptop computer, a desktop computer, or other computing device; a slate or tablet computing device (“tablet computing device”) 606B; a mobile computing device 606C such as a mobile telephone, a smart phone, an on-board computer, or other mobile computing device; a server computer 606D; and/or other devices 606N, which can include a hardware security module. It should be understood that any number of devices 606 can communicate with the computing environment 602. Two example computing architectures for the devices 606 are illustrated and described herein with reference to FIGS. 5 and 7. It should be understood that the illustrated devices 606 and computing architectures illustrated and described herein are illustrative only and should not be construed as being limited in any way.

In the illustrated configuration, the computing environment 602 includes application servers 608, data storage 610, and one or more network interfaces 612. According to various implementations, the functionality of the application servers 608 can be provided by one or more server computers that are executing as part of, or in communication with, the network 604. The application servers 608 can host various services, virtual machines, portals, and/or other resources. In the illustrated configuration, the application servers 608 host one or more virtual machines 614 for hosting applications or other functionality. According to various implementations, the virtual machines 614 host one or more applications and/or software modules for trust delegation. It should be understood that this configuration is illustrative only and should not be construed as being limiting in any way.

According to various implementations, the application servers 608 also include one or more of cluster structure services 620, strip and weight services 622, and detection services 624. The cluster structure services 620 can include services for storing and searching content data in a cluster structure. The strip and weight services 622 can include services for stripping high use-rate terms and phrases and weighting terms and phrases important to near-duplicate detection. The detection services 624 can include services such as detecting near-duplicate objects, provided risk predications, generating alerts or notifications, or blocking messages.

As shown in FIG. 6, the application servers 608 also can host other services, applications, portals, and/or other resources (“other resources”) 628. The other resources 628 can include, but are not limited to, data encryption, data sharing, or any other functionality.

As mentioned above, the computing environment 602 can include data storage 610. According to various implementations, the functionality of the data storage 610 is provided by one or more databases or data stores operating on, or in communication with, the network 604. The functionality of the data storage 610 also can be provided by one or more server computers configured to host data for the computing environment 602. The data storage 610 can include, host, or provide one or more real or virtual data stores 626A-826N (hereinafter referred to collectively and/or generically as “datastores 626”). The datastores 626 are configured to host data used or created by the application servers 608 and/or other data. Aspects of the datastores 626 may be associated with services for a trust delegation. Although not illustrated in FIG. 6, the datastores 626 also can host or store web page documents, word documents, presentation documents, data structures, algorithms for execution by a recommendation engine, and/or other data utilized by any application program or another module.

The computing environment 602 can communicate with, or be accessed by, the network interfaces 612. The network interfaces 612 can include various types of network hardware and software for supporting communications between two or more computing devices including, but not limited to, mobile client vehicles, the clients 606 and the application servers 608. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 may provide the software functionality described herein as a service to the clients using devices 606. It should be understood that the devices 606 can include real or virtual machines including, but not limited to, server computers, web servers, personal computers, mobile computing devices, smart phones, and/or other devices, which can include user input devices. As such, various configurations of the concepts and technologies disclosed herein enable any device configured to access the distributed computing environment 600 to utilize the functionality described herein for trust delegation, among other aspects.

Turning now to FIG. 7, an illustrative computing device architecture 700 for a computing device that is capable of executing various software components is described herein for trust delegation. The computing device architecture 700 is applicable to computing devices such as mobile clients in vehicles. In some configurations, the computing devices include, but are not limited to, mobile telephones, on-board computers, tablet devices, slate devices, portable video game devices, traditional desktop computers, portable computers (e.g., laptops, notebooks, ultra-portables, and netbooks), server computers, game consoles, and other computer systems. The computing device architecture 700 is applicable to the client devices 110A-C, server 120 and detection server 130 shown in FIG. 1 and computing devices 606A-N shown in FIG. 6.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individual components illustrated in FIG. 7, the components can interact to carry out device functions. In some configurations, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 may be utilized to execute aspects of the software components presented herein and, particularly, those that utilize, at least in part, secure data.

In some configurations, the processor 702 includes a graphics processing unit (“GPU”) configured to accelerate operations performed by the CPU, including, but not limited to, operations performed by executing secure computing applications, general-purpose scientific and/or engineering computing applications, as well as graphics-intensive computing applications such as high resolution video (e.g., 620P, 1080P, and higher resolution), video games, three-dimensional (“3D”) modeling applications, and the like. In some configurations, the processor 702 is configured to communicate with a discrete GPU (not shown). In any case, the CPU and GPU may be configured in accordance with a co-processing CPU/GPU computing model, wherein a sequential part of an application executes on the CPU and a computationally-intensive part is accelerated by the GPU.

In some configurations, the processor 702 is, or is included in, a system-on-chip (“SoC”) along with one or more of the other components described herein below. For example, the SoC may include the processor 702, a GPU, one or more of the network connectivity components 706, and one or more of the sensor components 708. In some configurations, the processor 702 is fabricated, in part, utilizing a package-on-package (“PoP”) integrated circuit packaging technique. The processor 702 may be a single core or multi-core processor.

The processor 702 may be created in accordance with an ARM architecture, available for license from ARM HOLDINGS of Cambridge, United Kingdom. Alternatively, the processor 702 may be created in accordance with an x86 architecture, such as is available from INTEL CORPORATION of Mountain View, Calif. and others. In some configurations, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some configurations, the RAM 714 or a portion thereof, the ROM 716 or a portion thereof, and/or some combination of the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 and/or the removable storage 720.

The integrated storage 718 can include a solid-state memory, a hard disk, or a combination of solid-state memory and a hard disk. The integrated storage 718 may be soldered or otherwise connected to a logic board upon which the processor 702 and other components described herein also may be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available as a total combined storage capacity. In some configurations, the total combined capacity of the integrated storage 718 and the removable storage 720 is shown to a user instead of separate storage capacities for the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system may include, but is not limited to, server operating systems such as various forms of UNIX certified by The Open Group and LINUX certified by the Free Software Foundation, or aspects of Software-as-a-Service (SaaS) architectures, such as MICROSOFT AZURE from Microsoft Corporation of Redmond, Wash. or AWS from Amazon Corporation of Seattle, Wash. The operating system may also include WINDOWS MOBILE OS from Microsoft Corporation of Redmond, Wash., WINDOWS PHONE OS from Microsoft Corporation, WINDOWS from Microsoft Corporation, MAC OS or IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from the network 756 or another network, which may be a WWAN, a WLAN, or a WPAN. Although only the network 756 is illustrated, the network connectivity components 706 may facilitate simultaneous communication with multiple networks, including the network 756 of FIG. 7. For example, the network connectivity components 706 may facilitate simultaneous communications with multiple networks via one or more of a WWAN, a WLAN, or a WPAN.

The network 756 may be or may include a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 756 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 756 may be configured to provide voice and/or data communications with any combination of the above technologies. The network 756 may be configured to or be adapted to provide voice and/or data communications in accordance with future generation technologies.

In some configurations, the WWAN component 722 is configured to provide dual-multi-mode connectivity to the network 756. For example, the WWAN component 722 may be configured to provide connectivity to the network 756, wherein the network 756 provides service via GSM and UMTS technologies, or via some other combination of technologies. Alternatively, multiple WWAN components 722 may be utilized to perform such functionality, and/or provide additional functionality to support other non-compatible technologies (i.e., incapable of being supported by a single WWAN component). The WWAN component 722 may facilitate similar connectivity to multiple networks (e.g., a UMTS network and an LTE network).

The network 756 may be a WLAN operating in accordance with one or more Institute of Electrical and Electronic Engineers (“IEEE”) 602.11 standards, such as IEEE 602.11a, 602.11b, 602.11g, 602.11n, and/or future 602.11 standard (referred to herein collectively as WI-FI). Draft 602.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 756 via the WI-FI access points. Such connections may be secured via various encryption technologies including, but not limited to, WI-FI Protected Access (“WPA”), WPA2, Wired Equivalent Privacy (“WEP”), and the like.

The network 756 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 728, an ambient light sensor 730, a proximity sensor 732, an accelerometer 734, a gyroscope 736, and a Global Positioning System sensor (“GPS sensor”) 738. It is contemplated that other sensors, such as, but not limited to, temperature sensors or shock detection sensors, also may be incorporated in the computing device architecture 700.

The I/O components 710 include a display 740, a touchscreen 742, a data I/O interface component (“data I/O”) 744, an audio I/O interface component (“audio I/O”) 746, a video I/O interface component (“video I/O”) 748, and a camera 750. In some configurations, the display 740 and the touchscreen 742 are combined. In some configurations two or more of the data I/O component 744, the audio I/O component 746, and the video I/O component 748 are combined. The I/O components 710 may include discrete processors configured to support the various interfaces described below or may include processing functionality built-in to the processor 702.

The illustrated power components 712 include one or more batteries 752, which can be connected to a battery gauge 754. The batteries 752 may be rechargeable or disposable. Rechargeable battery types include, but are not limited to, lithium polymer, lithium ion, nickel cadmium, and nickel metal hydride. Each of the batteries 752 may be made of one or more cells.

The power components 712 may also include a power connector, which may be combined with one or more of the aforementioned I/O components 710. The power components 712 may interface with an external power system or charging equipment via an I/O component.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The present disclosure is made in light of the following clauses:

Clause 1: A computer-implemented near-duplicate document detection method, the method comprising: receiving a message having message content; determining a message fingerprint based on at least part of the message content; determining whether the message is a near duplicate of another message by matching the message fingerprint to at least one fingerprint in a cluster of other messages; and if the message fingerprint matches at least one message in the cluster of other messages, adding an identifier for the message and the message fingerprint to the cluster of other messages.

Clause 2. The near-duplicate detection method of Clause 1, the method including: determining a risk level for the cluster of other messages; and if the risk level for the cluster is greater than a risk threshold, adding the fingerprints of the cluster of other messages to a risk list.

Clause 3. The method of Clause 2, the method including: receiving an inquiry message with inquiry message content; determining an inquiry message fingerprint based on at least part of the inquiry message content; searching the risk list for a fingerprint matching the inquiry message fingerprint; and if the fingerprint matching the inquiry message is found on the risk list, generating at least one of an alert, a notification, and a blocking message.

Clause 4. The method of Clause 1, the method including: receiving an inquiry message with inquiry message content; determining an inquiry message fingerprint based on at least part of the inquiry message content; searching one or more clusters of other messages for a fingerprint matching the inquiry message fingerprint; if the fingerprint matching the inquiry message fingerprint is found on a matching cluster of other messages, then determining a risk level for the matching cluster; and if the risk level for the matching cluster is greater than a risk threshold, generating at least one of an alert, a notification, and a blocking message if the message is a near-duplicate of any fingerprint on the risk list.

Clause 5. The method of Clause 4, the method including: training a risk detection model using machine learning applied to data for one or more clusters of other messages and one or more attributes to determine a risk level; and the step of determining a risk level for the matching cluster comprises predicting a risk level associated with the matching cluster of other messages using the risk detection model.

Clause 6. The method of Clause 5, where the one or more attributes includes one or more of a sender identifier, a number of messages sent by the sender, a number of accounts associated with the sender, or a description, price, or age of an item listing.

Clause 7. The method of Clause 1, wherein: the step of determining a message fingerprint based on at least part of the message content comprises mathematically generating a fingerprint corresponding to the part of the message content using a fingerprinting algorithm; and the step of determining whether the message is near duplicate of another message by matching the message fingerprint to at least one fingerprint in a cluster of other messages comprises determining whether the message fingerprint is within a predetermined distance metric of at least one fingerprint in a cluster of other messages.

Clause 8. A system for near-duplicate detection, the system comprising: one or more processors; and one or more memory devices in communication with the one or more processors, the memory devices having computer-readable instructions stored thereupon that, when executed by the processors, cause the processors to perform a method for near-duplicate detection, the method comprising: receiving a message having message content; determining a message fingerprint based on at least part of the message content; determining whether the message is a near duplicate of another message by matching the message fingerprint to at least one fingerprint in a cluster of other messages; and if the message fingerprint matches at least one message in the cluster of other messages, adding an identifier for the message and the message fingerprint to the cluster of other messages.

Clause 9. The near-duplicate detection system of Clause 8, the method including: determining a risk level for the cluster of other messages; and if the risk level for the cluster is greater than a risk threshold, adding the fingerprints of the cluster of other messages to a risk list.

Clause 10. The near-duplicate detection system of Clause 8, the method including: receiving an inquiry message with inquiry message content; determining an inquiry message fingerprint based on at least part of the inquiry message content; searching the risk list for a fingerprint matching the inquiry message fingerprint; and if the fingerprint matching the inquiry message is found on the risk list, generating at least one of an alert, a notification, and a blocking message.

Clause 11. The near-duplicate detection system of Clause 8, the method including: receiving an inquiry message with inquiry message content; determining an inquiry message fingerprint based on at least part of the inquiry message content; searching one or more clusters of other messages for a fingerprint matching the inquiry message fingerprint; if the fingerprint matching the inquiry message fingerprint is found on a matching cluster of other messages, then determining a risk level for the matching cluster; and if the risk level for the matching cluster is greater than a risk threshold, generating at least one of an alert, a notification, and a blocking message if the message is a near-duplicate of any fingerprint on the risk list.

Clause 12. The near-duplicate detection system of Clause 8, the method including: training a risk detection model using machine learning applied to data for one or more clusters of other messages and one or more attributes to determine a risk level; and the step of determining a risk level for the matching cluster comprises predicting a risk level associated with the matching cluster of other messages using the risk detection model.

Clause 13. The near-duplicate detection system of Clause 12, where the one or more attributes includes one or more of a sender identifier, a number of messages sent by the sender, a number of accounts associated with the sender, or a description, price, or age of an item listing.

Clause 14. The near-duplicate detection system of Clause 8, wherein: the step of determining a message fingerprint based on at least part of the message content comprises mathematically generating a fingerprint corresponding to the part of the message content using a fingerprinting algorithm; and the step of determining whether the message is near duplicate of another message by matching the message fingerprint to at least one fingerprint in a cluster of other messages comprises determining whether the message fingerprint is within a predetermined distance metric of at least one fingerprint in a cluster of other messages.

Clause 15. One or more computer storage media having computer executable instructions stored thereon which, when executed by one or more processors, cause the processors to execute a near-duplicate detection method, the method comprising: receiving a message having message content; determining a message fingerprint based on at least part of the message content; determining whether the message is a near duplicate of another message by matching the message fingerprint to at least one fingerprint in a cluster of other messages; and if the message fingerprint matches at least one message in the cluster of other messages, adding an identifier for the message and the message fingerprint to the cluster of other messages.

Clause 16. The computer storage media of Clause 15, where the near-duplicate detection method includes: determining a risk level for the cluster of other messages; if the risk level for the cluster is greater than a risk threshold, adding the fingerprints of the cluster of other messages to a risk list; receiving an inquiry message with inquiry message content; determining an inquiry message fingerprint based on at least part of the inquiry message content; searching the risk list for a fingerprint matching the inquiry message fingerprint; and if the fingerprint matching the inquiry message is found on the risk list, generating at least one of an alert, a notification, and a blocking message.

Clause 17. The computer storage media of Clause 15, where the near-duplicate detection method includes: receiving an inquiry message with inquiry message content; determining an inquiry message fingerprint based on at least part of the inquiry message content; searching one or more clusters of other messages for a fingerprint matching the inquiry message fingerprint; if the fingerprint matching the inquiry message fingerprint is found on a matching cluster of other messages, then determining a risk level for the matching cluster; and if the risk level for the matching cluster is greater than a risk threshold, generating at least one of an alert, a notification, and a blocking message if the message is a near-duplicate of any fingerprint on the risk list.

Clause 18. The computer storage media of Clause 15, where the near-duplicate detection method includes: training a risk detection model using machine learning applied to data for one or more clusters of other messages and one or more attributes to determine a risk level; and the step of determining a risk level for the matching cluster comprises predicting a risk level associated with the matching cluster of other messages using the risk detection model.

Clause 19. The computer storage media of Clause 15, where the one or more attributes includes one or more of a sender identifier, a number of messages sent by the sender, a number of accounts associated with the sender, or a description, price, or age of an item listing.

Clause 20. The computer storage media of Clause 15, wherein: the step of determining a message fingerprint based on at least part of the message content comprises mathematically generating a fingerprint corresponding to the part of the message content using a fingerprinting algorithm; and the step of determining whether the message is near duplicate of another message by matching the message fingerprint to at least one fingerprint in a cluster of other messages comprises determining whether the message fingerprint is within a predetermined distance metric of at least one fingerprint in a cluster of other messages.

What is claimed is:

1. A computer-implemented near-duplicate document detection method, the method comprising:
receiving a message having message content;
determining a message fingerprint based on at least part of the message content;
determining whether the message is a near duplicate of another message by matching the message fingerprint to at least one fingerprint in a cluster of other messages; and
if the message fingerprint matches at least one message in the cluster of other messages, adding an identifier for the message and the message fingerprint to the cluster of other messages.

2. The near-duplicate detection method of claim 1, the method including:
determining a risk level for the cluster of other messages; and
if the risk level for the cluster is greater than a risk threshold, adding the fingerprints of the cluster of other messages to a risk list.

3. The method of claim 2, the method including:
receiving an inquiry message with inquiry message content;
determining an inquiry message fingerprint based on at least part of the inquiry message content;
searching the risk list for a fingerprint matching the inquiry message fingerprint; and
if the fingerprint matching the inquiry message is found on the risk list, generating at least one of an alert, a notification, and a blocking message.

4. The method of claim 1, the method including:
receiving an inquiry message with inquiry message content;
determining an inquiry message fingerprint based on at least part of the inquiry message content;
searching one or more clusters of other messages for a fingerprint matching the inquiry message fingerprint;
if the fingerprint matching the inquiry message fingerprint is found on a matching cluster of other messages, then determining a risk level for the matching cluster; and
if the risk level for the matching cluster is greater than a risk threshold, generating at least one of an alert, a notification, and a blocking message if the message is a near-duplicate of any fingerprint on the risk list.

5. The method of claim 4, the method including:
training a risk detection model using machine learning applied to data for one or more clusters of other messages and one or more attributes to determine a risk level; and
the step of determining a risk level for the matching cluster comprises predicting a risk level associated with the matching cluster of other messages using the risk detection model.

6. The method of claim 5, where the one or more attributes includes one or more of a sender identifier, a number of messages sent by the sender, a number of accounts associated with the sender, or a description, price, or age of an item listing.

7. The method of claim 1, wherein:
the step of determining a message fingerprint based on at least part of the message content comprises mathematically generating a fingerprint corresponding to the part of the message content using a fingerprinting algorithm; and
the step of determining whether the message is near duplicate of another message by matching the message fingerprint to at least one fingerprint in a cluster of other messages comprises determining whether the message fingerprint is within a predetermined distance metric of at least one fingerprint in a cluster of other messages.

8. A system for near-duplicate detection, the system comprising:
one or more processors; and
one or more memory devices in communication with the one or more processors, the memory devices having computer-readable instructions stored thereupon that, when executed by the processors, cause the processors to perform a method for near-duplicate detection, the method comprising:
receiving a message having message content;
determining a message fingerprint based on at least part of the message content;
determining whether the message is a near duplicate of another message by matching the message fingerprint to at least one fingerprint in a cluster of other messages; and
if the message fingerprint matches at least one message in the cluster of other messages, adding an identifier for the message and the message fingerprint to the cluster of other messages.

9. The near-duplicate detection system of claim 8, the method including:
determining a risk level for the cluster of other messages; and
if the risk level for the cluster is greater than a risk threshold, adding the fingerprints of the cluster of other messages to a risk list.

10. The near-duplicate detection system of claim 9, the method including:
receiving an inquiry message with inquiry message content;
determining an inquiry message fingerprint based on at least part of the inquiry message content;
searching the risk list for a fingerprint matching the inquiry message fingerprint; and
if the fingerprint matching the inquiry message is found on the risk list, generating at least one of an alert, a notification, and a blocking message.

11. The near-duplicate detection system of claim 8, the method including:
receiving an inquiry message with inquiry message content;
determining an inquiry message fingerprint based on at least part of the inquiry message content;
searching one or more clusters of other messages for a fingerprint matching the inquiry message fingerprint;
if the fingerprint matching the inquiry message fingerprint is found on a matching cluster of other messages, then determining a risk level for the matching cluster; and
if the risk level for the matching cluster is greater than a risk threshold, generating at least one of an alert, a notification, and a blocking message if the message is a near-duplicate of any fingerprint on the risk list.

12. The near-duplicate detection system of claim 11, the method including:
training a risk detection model using machine learning applied to data for one or more clusters of other messages and one or more attributes to determine a risk level; and
the step of determining a risk level for the matching cluster comprises predicting a risk level associated with the matching cluster of other messages using the risk detection model.

13. The near-duplicate detection system of claim 12, where the one or more attributes includes one or more of a sender identifier, a number of messages sent by the sender, a number of accounts associated with the sender, or a description, price, or age of an item listing.

14. The near-duplicate detection system of claim 8, wherein:
the step of determining a message fingerprint based on at least part of the message content comprises mathematically generating a fingerprint corresponding to the part of the message content using a fingerprinting algorithm; and
the step of determining whether the message is near duplicate of another message by matching the message fingerprint to at least one fingerprint in a cluster of other messages comprises determining whether the message fingerprint is within a predetermined distance metric of at least one fingerprint in a cluster of other messages.

15. One or more computer storage media having computer executable instructions stored thereon which, when executed by one or more processors, cause the processors to execute a near-duplicate detection method, the method comprising:
receiving a message having message content;
determining a message fingerprint based on at least part of the message content;
determining whether the message is a near duplicate of another message by matching the message fingerprint to at least one fingerprint in a cluster of other messages; and
if the message fingerprint matches at least one message in the cluster of other messages, adding an identifier for the message and the message fingerprint to the cluster of other messages.

16. The computer storage media of claim 15, where the near-duplicate detection method includes:
determining a risk level for the cluster of other messages;
if the risk level for the cluster is greater than a risk threshold, adding the fingerprints of the cluster of other messages to a risk list;
receiving an inquiry message with inquiry message content;
determining an inquiry message fingerprint based on at least part of the inquiry message content;
searching the risk list for a fingerprint matching the inquiry message fingerprint; and
if the fingerprint matching the inquiry message is found on the risk list, generating at least one of an alert, a notification, and a blocking message.

17. The computer storage media of claim 16, where the near-duplicate detection method includes:
receiving an inquiry message with inquiry message content;
determining an inquiry message fingerprint based on at least part of the inquiry message content;
searching one or more clusters of other messages for a fingerprint matching the inquiry message fingerprint;
if the fingerprint matching the inquiry message fingerprint is found on a matching cluster of other messages, then determining a risk level for the matching cluster; and
if the risk level for the matching cluster is greater than a risk threshold, generating at least one of an alert, a notification, and a blocking message if the message is a near-duplicate of any fingerprint on the risk list.

18. The computer storage media of claim 17, where the near-duplicate detection method includes:
training a risk detection model using machine learning applied to data for one or more clusters of other messages and one or more attributes to determine a risk level; and
the step of determining a risk level for the matching cluster comprises predicting a risk level associated with the matching cluster of other messages using the risk detection model.

19. The computer storage media of claim 18, where the one or more attributes includes one or more of a sender identifier, a number of messages sent by the sender, a number of accounts associated with the sender, or a description, price, or age of an item listing.

20. The computer storage media of claim 15, wherein:
the step of determining a message fingerprint based on at least part of the message content comprises mathematically generating a fingerprint corresponding to the part of the message content using a fingerprinting algorithm; and
the step of determining whether the message is near duplicate of another message by matching the message fingerprint to at least one fingerprint in a cluster of other messages comprises determining whether the message fingerprint is within a predetermined distance metric of at least one fingerprint in a cluster of other messages.
